(19) United States
(12) Patent Application Publication
(10) Pub. No.: US 2026/0324836 A1
(43) Pub. Date: Oct. 22, 2026

(54) LIP GLOSS CARTRIDGE AND REFILLABLE LIP GLOSS USING SAME

(71) Applicant: CTK CO., LTD., Seoul (KR)

(72) Inventors: In Yong CHUNG, Seoul (KR); Won Eui LEE, Seoul (KR); In Young UM, Seoul (KR)

(21) Appl. No.: 19/113,853

(22) PCT Filed: Aug. 3, 2024
(86) PCT No.: PCT/KR2023/011392

§ 371 Date: Mar. 20, 2025

(30) Foreign Application Priority Data
Nov. 7, 2022 (KR) KR10-2022-0146641

(51) Int. Cl. A45D 40/26; A45D 40/00

(52) U.S. Cl. CPC A45D 40/26; A45D 40/0068

(57) ABSTRACT

The present invention relates to a jar-type cosmetic container and, more specifically, to a jar-type cosmetic container with a scraper that is used as a massage tool, wherein an inner cap and an outer cap can be detached simultaneously or separately according to whether cosmetic contents using the scraper are to be used, thus making it highly convenient to use the scraper portably and enabling quick and convenient withdrawal of the cosmetic contents. To this end, the jar-type cosmetic container comprises: a container body in which an accommodation space for accommodating the cosmetic contents is open in one direction, and an inlet port is provided at an open top end; an inner cap that can be opened and closed by being screwed to and unscrewed from the inlet port and has an inwardly recessed scraper storage part in which the scraper is placed on one side; and an outer cap that is cover-coupled to the outside of the inner cap so that arbitrary detachment is prevented by an arbitrary detachment prevention means, and can be opened and closed separately from the inner cap as needed or opened and closed as a single body with the inner cap by a simultaneous rotation opening/closing means.

### TECHNICAL FIELD

The present disclosure relates to a jar-type cosmetic container. More particularly, the present disclosure relates to a jar-type cosmetic container with a scraper, wherein an inner cap and an outer cap are detached and used simultaneously or separately according to whether cosmetic contents using the scraper that is used as a massage tool are used, thus providing high convenience for portable use of the scraper and enabling quick convenient withdrawal of the cosmetic contents.

### BACKGROUND ART

In general, jar-type cosmetic containers are mainly used to contain low-viscosity cosmetic contents such as creams inside a container body. Furthermore, when the cosmetic contents are used, a lid and an inner cover are opened sequentially, and the cosmetic contents are withdrawn with a separate cosmetic tool such as a finger or a spatula.

However, conventional jar-type cosmetic containers are mainly configured to apply the cosmetic contents with directly using fingers, so there is no structure for storing a separate cosmetic tool therein. Of course, the cosmetic tool may be mounted to an upper part of the lid, but the lid is provided to prevent the contents from being on the lid, so there is a structural limitation for storing cosmetic tools.

Of course, in recent years, an inner lid has been formed to be deeply depressed to store a variety of cosmetic tools therein. However, in this case, it is difficult to avoid the hassle occurring during withdrawal and use of the cosmetic contents because the lid and inner lid must always be opened sequentially to use the cosmetic contents, regardless of whether a cosmetic tool is used or not. Furthermore, due to the structure of the inner lid, which is separated from the container body, caution is required with the risk of loss or separated storage, and it is difficult to avoid the risk of contamination due to carelessness.

### DOCUMENTS OF RELATED ART

### Patent Document

(Patent Document 1) KR1020200001681 A (Date of Publication: Jan 7, 2020)

### DISCLOSURE

### Technical Problem

Accordingly, the present disclosure has been made keeping in mind the above problems occurring in the related art, and an objective of the present disclosure is to provide a jar-type cosmetic container with a scraper, which is capable of providing high convenience for portable use of the scraper and enabling quick convenient withdrawal of cosmetic contents with an inner cap and an outer cap, which are detached and used simultaneously or separately according to whether the cosmetic contents using the scraper are used.

### Technical Solution

According to the present disclosure, there is provided a jar-type cosmetic container with a scraper, the jar-type cosmetic container including: a container body in which an accommodation space for accommodating cosmetic contents may be open in one direction, and an inlet port may be provided at an upper end of the opening; an inner cap operated to be opened and closed by being screwed to and unscrewed from the inlet port of the container body and having an inwardly depressed scraper storage part in which the scraper may be placed on one portion; and an outer cap cover-coupled to an outside portion of the inner cap so that arbitrary detachment may be prevented by an arbitrary detachment prevention means, and operated to be opened and closed separately from the inner cap as needed or to be opened and closed integrally with the inner cap by a simultaneous rotation opening/closing means.

According to the present disclosure, the inlet port of the container body may be covered with an auxiliary cover.

According to the present disclosure, the inlet port of the container body may be closed airtightly by a packing that may be provided at a lower end of a separation wall of the inner cap, the lower end being brought into close contact with an upper surface of the inlet port when the inner cap is closed.

According to the present disclosure, the arbitrary detachment prevention means may include an undercut protrusion and an undercut groove, and the undercut protrusion may be formed around an outer circumferential surface of a lower end of a side wall of the inner cap, and the undercut groove may be formed around a corresponding inner circumferential surface of a lower end of the outer cap so that the undercut groove and the undercut protrusion may be caught by each other.

Furthermore, according to the present disclosure, the arbitrary detachment prevention means may include an undercut protrusion and an undercut groove, and the undercut protrusion may be formed around an inner circumferential surface of an upper end of a side wall of the inner cap, and the undercut groove may be formed on a corresponding outer circumferential surface of a support rib extending downwards from an inner circumferential surface of the outer cap so that the undercut groove and the undercut protrusion may be caught by each other.

According to the present disclosure, the simultaneous rotation opening/closing means may include caught grooves and caught ribs, and the caught grooves may be formed longitudinally around an outer circumferential surface of a side wall of the inner cap at constant intervals, and the caught ribs may be formed by protruding on a corresponding inner circumferential surface of the outer cap so that the caught ribs and the caught grooves may be caught by each other at one or more locations, and the inner cap and the outer cap coupled to each other with the caught grooves and the caught ribs caught by each other may be detached separately from each other by pulling the outer cap vertically against the inner cap, and the outer cap and the inner cap may be opened and closed together by rotating the outer cap in the caught state.

Furthermore, according to the present disclosure, the simultaneous rotation opening/closing means may include one or more caught ribs and caught grooves, and the caught ribs may be formed by protruding on an inner circumferential surface of an upper end of a side wall of the inner cap at proper intervals, and the caught grooves may be formed longitudinally around a corresponding outer circumferential surface of a support rib extending downward from an inner circumferential surface of the outer cap, at certain intervals, and having a wave-like form or a similar form thereto so that the caught ribs and the caught grooves may be caught by each other at one or more locations, and the inner cap and the outer cap coupled to each other with the caught ribs and the caught grooves caught by each other may be detached separately from each other by pulling the outer cap vertically against the inner cap, and the outer cap and the inner cap may be opened and closed together by rotating the outer cap in the caught state.

Furthermore, according to the present disclosure, the simultaneous rotation opening/closing means may include a polygonal surface formed vertically around an outer circumferential surface of a side wall of the inner cap, and a polygonal surface formed around a corresponding inner circumferential surface of the outer cap so that the polygonal surfaces may be contact-caught to each other, and the inner cap and the outer cap coupled to each other with the polygonal surfaces in contact with each other may be detached separately from each other by pulling the outer cap vertically against the inner cap, and the outer cap and the inner cap may be opened and closed together by rotating the outer cap with the polygonal surfaces in contact with each other.

According to the present disclosure, an inner container for accommodating the cosmetic contents may be coupled to the accommodation space of the container body to be detachable with respect to the inlet port, and an open end of the inner container may be covered with the auxiliary cover.

### Advantageous Effects

According to the present disclosure, the scraper used as a massage tool is stored inside the inner cap so that portable use of the scraper can be convenient, and the outer cap cover-coupled to the outer portion of the inner cap is detached separately from the inner cap or rotated and detached together with the inner cap so that appropriate opening and closing of the inner cap and the outer cap are selectively and easily performed according to whether the scraper is used or not, thus allowing quick and convenient use of the cosmetic contents.

### DESCRIPTION OF DRAWINGS

FIG. 1 is an assembled perspective view of a cosmetic container according to the present disclosure.

FIG. 2 is an exploded perspective view of the cosmetic container according to the present disclosure.

FIG. 3 is an assembled sectional view showing a structure of an arbitrary detachment prevention means of an embodiment in the cosmetic container according to the present disclosure.

FIG. 4 is an assembled sectional view showing a structure of the arbitrary detachment prevention means of another embodiment in the cosmetic container according to the present disclosure.

FIG. 5 is a view showing a structure of a simultaneous rotation opening/closing means of an embodiment, and the view is a cross-sectional view taken along line 5A-5A of FIG. 3.

FIG. 6 is an assembled sectional view illustrating a structure of the rotation opening/closing means of another embodiment in the cosmetic container according to the present disclosure.

FIG. 7 is a cross-sectional view taken along line 7A-7A of FIG. 6.

FIG. 8 is an assembled sectional view illustrating a structure of the rotation opening/closing means of another embodiment in the cosmetic container according to the present disclosure.

FIG. 9 is a cross-sectional view taken along line 9A-9A of FIG. 8.

FIG. 10 is a sectional view showing an opened state of the cosmetic container according to the present disclosure, in which only an outer cap is detached and opened with respect to an inner cap.

FIG. 11 is a sectional view showing an opened state of the cosmetic container according to the present disclosure, in which both the inner cap and the outer cap are detached and opened at the same time.

FIGS. 12 and 13 are views each showing an operational example of using cosmetic contents by using a scraper while the inner cap and the outer cap are removed with respect to the cosmetic container according to the present disclosure.

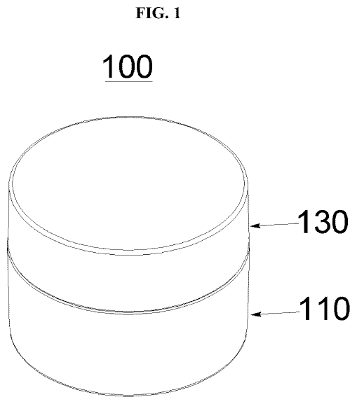

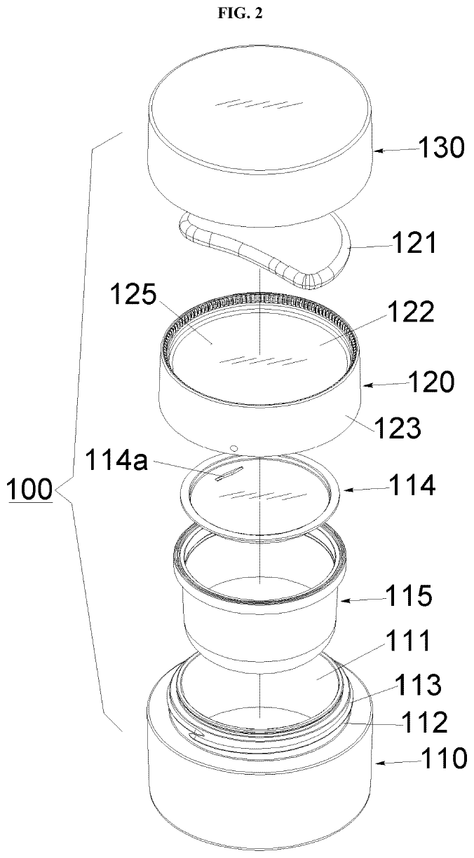

### BEST MODE

The above and other objects, features and advantages of the present disclosure will be more clearly understood from the following detailed description taken in conjunction with the accompanying drawings. Reference now should be made to the drawings, in which the same reference numerals are used throughout the different drawings to designate the same or similar components. Further, when it is determined that the detailed description of the known art related to the present disclosure might obscure the gist of the present disclosure, the detailed description thereof will be omitted.

Hereinbelow, exemplary embodiments according to the present disclosure will be described in detail with reference to accompanying drawings.

Referring to the accompanying drawings, according to the present disclosure, a jar-type cosmetic container 100 with a scraper may include: a container body 110 in which an accommodation space 111 for accommodating cosmetic contents is opened in one direction, and an inlet port 112 is provided at an upper end of the opening; an inner cap 120 opened and closed by being screwed to and unscrewed from the inlet port of the container body, and having an inwardly depressed scraper storage part 122 in which a scraper 121 is placed on one portion; and an outer cap 130 cover-coupled to an outer portion of the inner cap so that arbitrary detachment is prevented by an arbitrary detachment prevention means 140, opened and closed separately from the inner cap as needed, or to be opened and closed simultaneously with the inner cap by a simultaneous rotation opening/closing means 150.

An internal space of the accommodation space 111 formed to be open in one direction of the container body 110 accommodates the cosmetic contents P, and the cosmetic contents may be cream type contents.

However, the cosmetic contents are not necessarily limited thereto and may be different types of cosmetic contents having viscosity enough to be used with the scraper 121, which is a massage tool, or to be applied with a user's finger, etc. When the user puts on makeup with a puff, a cosmetic brush, etc., as different tools rather than a scraper, the cosmetic contents may be appropriately accommodated and used.

A screw part 113 is formed on an outer circumferential surface of the inlet port 112 provided at an upper end of the opening of the accommodation space 111.

The accommodation space 111 of the container body 110 may be covered with an auxiliary cover 114 supported to be caught by an inner portion of an upper end of the inlet port 112.

The auxiliary cover 114 is provided to be detached from the inlet port 112 to open the accommodation space 111 when the cosmetic contents P are used. To this end, a handle 114a may be provided as needed.

The inner cap 120 is opened and closed to block the inlet port of the container body and has a screw part 124 on an inner circumferential surface of a lower end of a side wall 123, and the screw part 124 corresponds to and is coupled to the screw part 113 of the inlet port 112.

Each screw part 113, 124 provided at each of the inlet port 112 and the side wall 123 may have a structure in which the screw parts are screwed and coupled by rotating the inner cap 120 clockwise against the inlet port and are unscrewed and detached from each other by rotating the inner cap counterclockwise.

Furthermore, the scraper storage part 122 provided at one portion of the inner cap 120 is separately formed by a separation wall 125 formed across the side wall 123, and has an inwardly depressed form to allow the scraper 121 to be stably stored and supported.

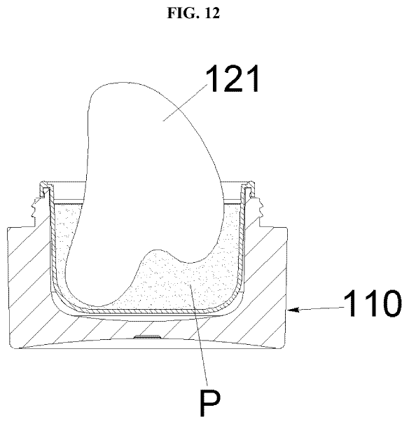

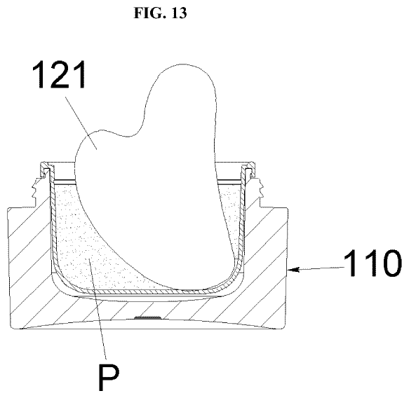

The scraper 121 stored in the scraper storage part 122 is one of massage tools, and may have different forms or materials depending on its use or function. As shown in FIGS. 12 and 13, the cosmetic contents P accommodated in the accommodation space 111 of the container body 110 or an inner container 115 may be applied with the scraper and used to do massage or makeup.

Furthermore, a packing 126 may be provided at a lower surface of the separation wall 125 of the inner cap 120 in a variety of methods such as attachment, and the packing 126 is made of an elastic material for hermetically blocking the inlet port 112 of the container body 110 covered with the auxiliary cover 114 or made of a variety of materials that replace the elastic material.

When the inner cap 120 is locked and coupled to the inlet port 112 of the container body 110 through the packing 126, an upper surface of the inlet port 112 may be hermetically blocked, thus preventing outward leakage of the cosmetic contents P accommodated in the accommodation space 111 when carried.

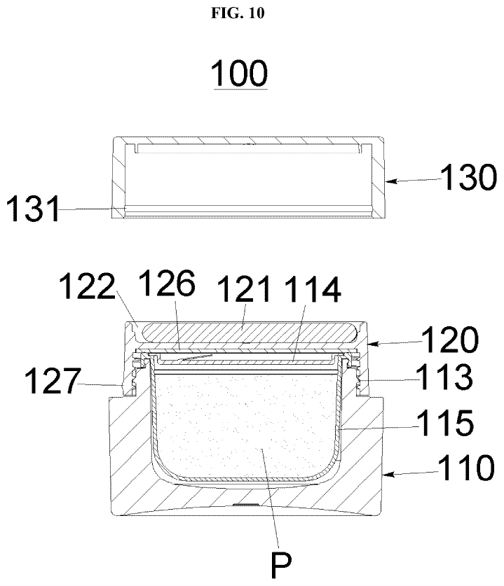

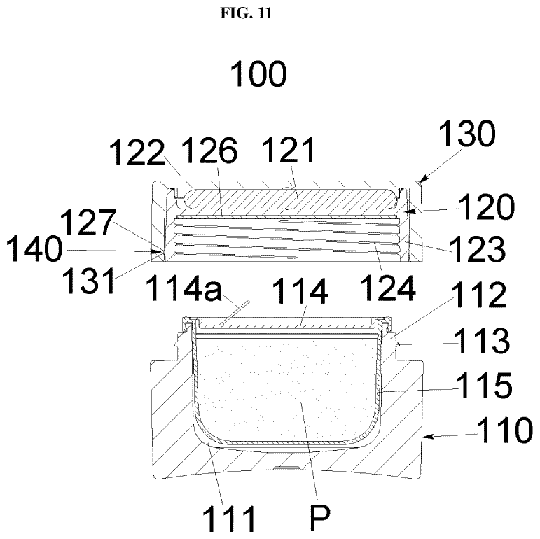

The outer cap 130 is cover-coupled to an outer portion of the inner cap 120. When necessary, the outer cap 130 may be opened and closed separately from the inner cap 120 as shown in FIG. 10, or may be opened and closed together with the inner cap 120 as shown in FIG. 11.

The cover-coupling of the outer cap 130 may allow the scraper 121 stored in the scraper storage part 122 of the inner cap 120 to be portable storage stably at all times.

Meanwhile, it is preferable that the outer cap 130 cover-coupled to the inner cap 120 is artificially detached and opened by the arbitrary detachment prevention means 140.

The arbitrary detachment prevention means 140 for preventing arbitrary detachment of the outer cap 130 from the inner cap 120 may have various embodied structures.

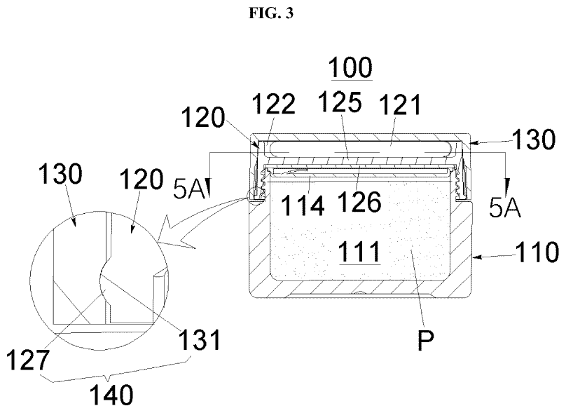

As an example, as shown in FIG. 3, the arbitrary detachment prevention means 140 may include an undercut protrusion 127 formed along an outer circumferential surface of the lower end of the side wall 123 of the inner cap 120, and an undercut groove 131 formed along a corresponding inner circumferential surface of a lower end of the outer cap 130 so that the undercut protrusion and the undercut groove 131 are caught by each other.

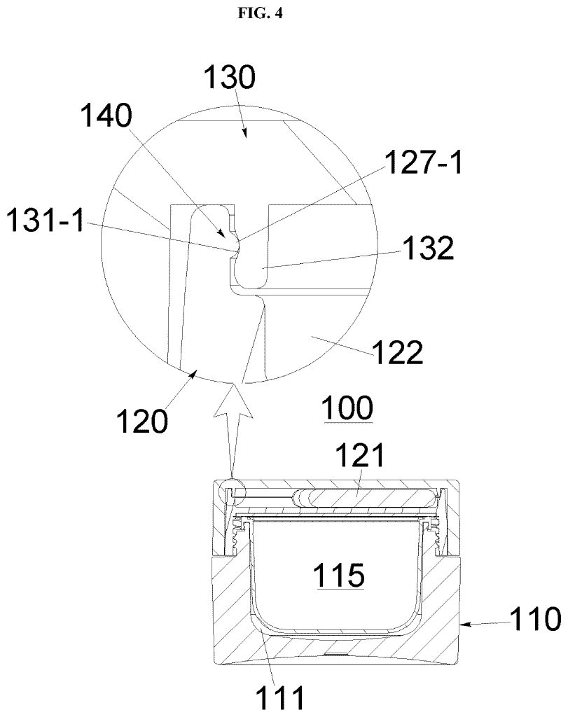

Furthermore, as another example, as shown in FIG. 4, the arbitrary detachment prevention means 140 may include an undercut protrusion 127-1 formed around an inner circumferential surface of an upper end of the side wall 123 of the inner cap 120, and an undercut groove 131-1 formed on a corresponding outer circumferential surface of a support rib 132 extending downward from an inner circumferential surface of the outer cap 130 so that the undercut groove and the undercut protrusion are caught by each other.

The undercut protrusion 127, 127-1 and the undercut groove 131, 131-1 constituting the arbitrary detachment prevention means 140 may be formed intermittently or continuously, and formed in opposite directions.

Preferably, since the arbitrary detachment prevention means 140 only needs to have enough elastic coupling force to prevent arbitrary detachment between the inner cap and the outer cap, unless the outer cap 130 is intentionally opened from the inner cap 120, specifically, it is preferable to intermittently form the undercut protrusion 127, 127-1 elastically caught by the undercut groove 131, 131-1 so that elastic lock-coupling or releasing is performed smoothly, quickly, and efficiently.

In addition, the simultaneous rotation opening/closing means 150 may allow the inner cap 120 and the outer cap 130 to be detached and opened separately from each other or rotated to be opened and closed together, as needed.

In addition, the outer cap 130 is detached and opened separately from the inner cap 120, when the cosmetic contents is to be used with the scraper 121 stored in the scraper storage part 122 of the inner cap 120 (referring to FIG. 10), and the outer cap 130 and the inner cap 120 may be opened simultaneously when the cosmetic contents P is directly used without the scraper 121.

As the inner cap 120 and the outer cap 130 are detached separately or simultaneously as needed, the cap opening and closing can be easily performed according to whether the scraper 121 is used.

The simultaneous rotation opening/closing means 150 for rotating and opening/closing the inner cap 120 and the outer cap 130 may have various embodied structures.

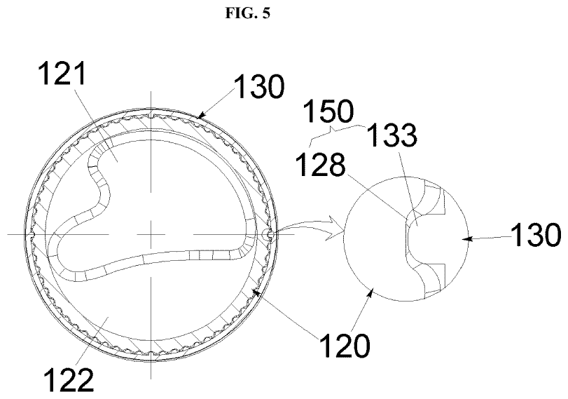

As an example, as shown in FIGS. 4 and 5, the simultaneous rotation opening/closing means 150 may include caught grooves 128 having a wave-like form that is formed around an outer circumferential surface of the side wall 123 of the inner cap 120 at constant intervals in a longitudinal direction or a similar form, and caught ribs 133 formed by protruding on a corresponding inner circumferential surface of the outer cap 130 so that the caught grooves and the caught ribs are caught by each other at one or more locations.

Therefore, the inner cap 120 and the outer cap 130 coupled to each other with the caught grooves 128 and the caught ribs 133 caught by each other may be detached separately from each other by pulling the outer cap 130 vertically against the inner cap 120, and opened and closed together with the inner cap 120 by rotating the outer cap 130 in the caught state.

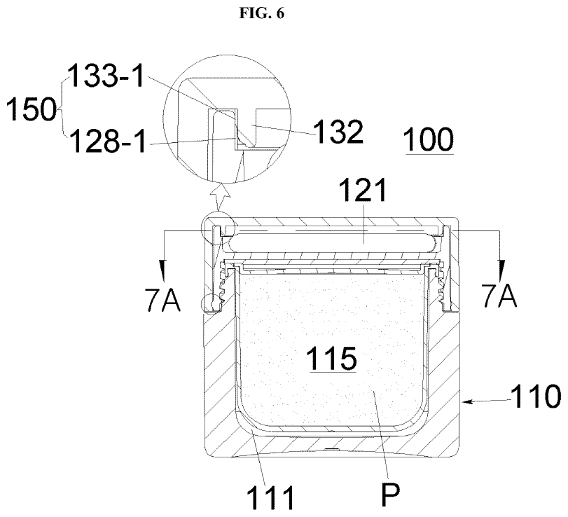

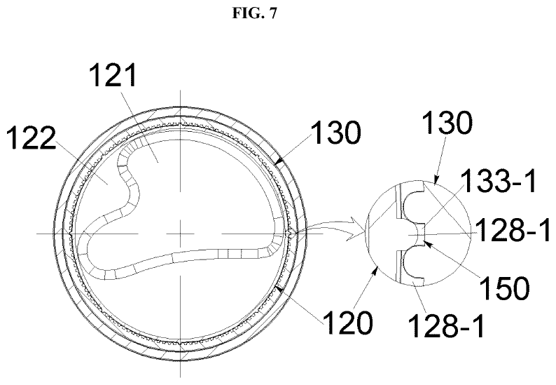

Furthermore, as another example, as shown in FIGS. 6 and 7, the simultaneous rotation opening/closing means 150 may include caught ribs 128-1 and caught grooves 133-1, and one or more caught ribs 128-1 are formed by protruding on an inner circumferential surface of an upper end of the side wall 123 of the inner cap 120 at appropriate intervals, and the caught grooves 133-1 each have a save form that is formed at certain intervals longitudinally around a corresponding outer circumferential surface of the support rib 132 extending downwards from an inner circumferential surface of the outer cap 130, or a similar form, so that the caught ribs and the caught grooves are caught by each other at one or more locations.

The inner cap 120 and the outer cap 130 coupled to each other with the caught ribs 128-1 and the caught grooves 133-1 that have the above-described structures to be caught by each other may be detached separately from each other by pulling the outer cap 130 vertically against the inner cap 120, and opened and closed together by rotating the outer cap 130 in the caught state.

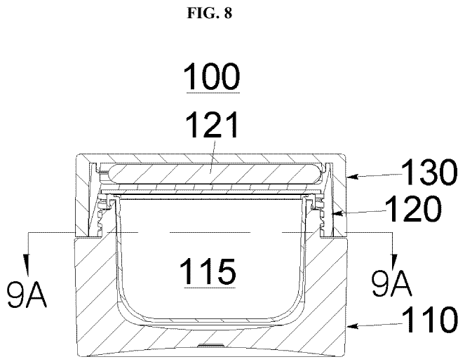

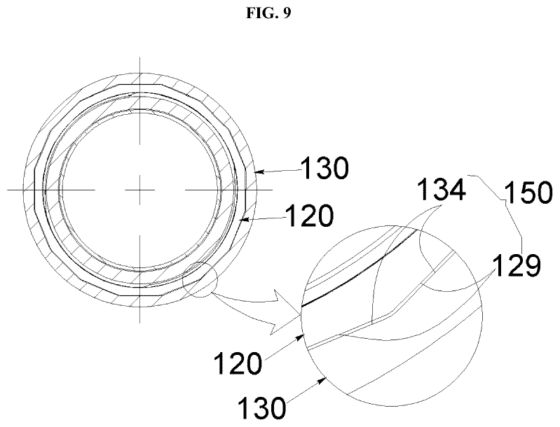

Furthermore, as another example, as shown in FIGS. 8 and 9, the simultaneous rotation opening/closing means 150 may include a polygonal surface 129 formed vertically around the outer circumferential surface of the side wall 123 of the inner cap 120, and a polygonal surface 134 formed around a corresponding inner circumferential surface of the outer cap 130 so that the polygonal surfaces are contact-caught by each other.

The inner cap 120 and the outer cap 130 coupled to each other with the caught ribs 128-1 and the caught grooves 133-1 that have the above-described structures to be caught by each other may be detached separately from each other by pulling the outer cap 130 vertically against the inner cap 120, and opened and closed together by rotating the outer cap 130 in the polygonal surface contact state.

According to the present disclosure, in the accommodation space 111 of the container body 110, the inner container 115 for accommodating the cosmetic contents P may be coupled to the inlet port 112 to be detachable, and the auxiliary cover 114 may cover the open end of the inner container 115.

As described above, as the separate inner container 115 is coupled to the accommodation space 111 of the container body 110, only the inner container may be replaced and used as needed.

An operational state of the above-described jar-type cosmetic container 100 with a scraper of the present disclosure will be described.

First, the use of the cosmetic contents P accommodated in the accommodation space 111 with the scraper 121 stored in the scraper storage part 122 of the inner cap 120 will be described as follows.

In this case, as shown in FIG. 11, the outer cap 130 may be forcibly detached from the inner cap 120. The outer cap is caught and coupled to the inner cap by the arbitrary detachment prevention means 140, but since the inner cap 120 is screwed to the inlet port 112 of the container body 110, coupling force of the arbitrary detachment prevention means 140 is eliminated by pulling the outer cap 130 outwards so that the outer cap may be easily detached, and even when the outer cap and the inner cap are engaged with each other by the simultaneous rotation opening/closing means 150, the outer cap and the inner cap may be simply detached from each other without interference.

As the same method, when the outer cap 130 is forcibly detached from the inner cap 120, the scraper storage part 122 of the inner cap 120 is opened, and the scraper 121 can be taken out.

After the scraper 121 is taken out, the inner cap 120 is secondarily rotated against the inlet port 112 of the container body 110.

After the inner cap is rotated and opened and the auxiliary cover 114 is removed, the cosmetic contents P accommodated in the accommodation space 111 of the container body 110 or the inner container 115 may be exposed outwards.

Furthermore, as shown in FIGS. 12 and 13, for the outwardly exposed cosmetic contents P, the user can hold the scraper 121, apply the cosmetic contents with the scraper, and use the cosmetic contents to do massage or makeup.

When massage or makeup using the scraper 121 as described above is completed, as opposed to the opening, the auxiliary cover 114 covers the upper surface of the inlet port 112, the inner cap 120 is closed, the scraper 121 is stored in the scraper storage part 122, and then the outer cap 130 is closed. By the closing operation of the outer cap, the outer cap is safely caught and coupled to the inner cap 120 without detachment from the inner cap due to elastic locking of the arbitrary detachment prevention means 140 (referring to FIGS. 3 and 4), and simultaneously, the coupling is performed with the simultaneous rotation opening/closing means 150 in the engaged state (referring to FIGS. 5, 7, and 9).

Of course, when the scraper 121 is used, as described above, the cap opening and closing are performed by opening the outer cap 130 primarily, and opening the inner cap 120 secondarily or reversely closing the inner cap and the outer cap, and it is obvious to use the scraper in a method by opening the inner cap 120 from the inlet port 112 of the container body 110 at a time through the opening of the outer cap 130 as shown in FIG. 11, and opening the outer cap 130 separately, or coupling the outer cap 130 first to the inner cap 120 and then locating the inner cap at the inlet port 112 of the container body 110 and rotating and closing the outer cap 130.

Meanwhile, when the user directly uses the cosmetic contents P without the scraper 121, as shown in FIG. 11, the outer cap 130 is opened simultaneously with the inner cap 120. Accordingly, the cosmetic contents accommodated in the accommodation space 111 of the container body 110 may be exposed outwards by removing the auxiliary cover, and used directly with a finger, etc.

More specifically for this, when the outer cap 130 is rotated while being held, the outer cap is caught integrally with the inner cap 120 by the simultaneous rotation opening/closing means 150 so that the outer cap 130 is rotated together with the inner cap and quickly detached and opened from the inlet port 112 of the container body 110.

Therefore, since the inner cap 120 does not need to be opened and can be quickly opened integrally with rotation of the outer cap 130, the convenience of quick use of the cosmetic contents accommodated in the accommodation space 111 of the container body 110 can be provided.

Furthermore, the inner cap 120 and the outer cap 130 remain coupled to each other in an integral body by the arbitrary detachment prevention means 140 even after being detached from the inlet port of the container body, and even when the inner cap 120 and the outer cap 130 are reclosed after use of the cosmetic contents, the inner cap 120 and the outer cap 130 are closed simultaneously by locating the inner cap 120 at the inlet port of the container body and then holding and rotating the outer cap in the closing direction, so quick closing of the cap can be performed.

As described above, the present disclosure can be configured to provide the high usability of the product as the inner cap 120 and the outer cap 130 are removed separately or simultaneously as needed to allow convenient detachment of the cap according to the use of the scraper 121 and convenient portable use of the scraper.

Although the present disclosure has been described with reference to the accompanying drawings, the present disclosure is not limited thereto, and it is apparent to one of ordinary skill in the art that the present disclosure may be changed and modified in various ways without departing from the scope and spirit of the present disclosure as disclosed in the accompanying claims. For example, the scraper storage part is claimed for the scraper to be mounted, but as an alternative cosmetic tool, a puff, a cosmetic brush, or the like may be stored instead of the scraper.

### DESCRIPTION OF REFERENCE NUMERALS

110: container body 111: accommodation space
112: inlet port 114: auxiliary cover
115: inner container 120: inner cap
121: scraper 122: scraper storage part
123: side wall 125: separation wall
126: packing 127, 127-1: undercut protrusion
128,133-1: caught groove 128-1, 133: caught rib
129, 134: polygonal surface 130: outer cap
131,131-1: undercut groove 132: support rib
140: arbitrary detachment prevention means 150: simultaneous rotation opening/closing means

1. A jar-type cosmetic container with a scraper, the jar-type cosmetic container comprising:
a container body in which an accommodation space for accommodating cosmetic contents is open in one direction, and an inlet port is provided at an upper end of the opening;
an inner cap operated to be opened and closed by being screwed to and unscrewed from the inlet port of the container body and having an inwardly depressed scraper storage part in which the scraper is placed on one portion; and
an outer cap cover-coupled to an outside portion of the inner cap so that arbitrary detachment is prevented by an arbitrary detachment prevention means, and operated to be opened and closed separately from the inner cap as needed or to be opened and closed integrally with the inner cap by a simultaneous rotation opening/closing means.

2. The jar-type cosmetic container of claim 1, wherein the inlet port of the container body is covered with an auxiliary cover.

3. The jar-type cosmetic container of claim 1, wherein the inlet port of the container body is closed airtightly by a packing that is provided at a lower end of a separation wall of the inner cap, the lower end being brought into close contact with an upper surface of the inlet port when the inner cap is closed.

4. The jar-type cosmetic container of claim 1, wherein the arbitrary detachment prevention means comprises an undercut protrusion and an undercut groove, and the undercut protrusion is formed around an outer circumferential surface of a lower end of a side wall of the inner cap, and the undercut groove is formed around a corresponding inner circumferential surface of a lower end of the outer cap so that the undercut groove and the undercut protrusion are caught by each other.

5. The jar-type cosmetic container of claim 1, wherein the arbitrary detachment prevention means comprises an undercut protrusion and an undercut groove, and the undercut protrusion is formed around an inner circumferential surface of an upper end of a side wall of the inner cap, and the undercut groove is formed on a corresponding outer circumferential surface of a support rib extending downwards from an inner circumferential surface of the outer cap so that the undercut groove and the undercut protrusion are caught by each other.

6. The jar-type cosmetic container of claim 1, wherein the simultaneous rotation opening/closing means comprises caught grooves and caught ribs, and the caught grooves are formed longitudinally around an outer circumferential surface of a side wall of the inner cap at constant intervals, and the caught ribs are formed by protruding on a corresponding inner circumferential surface of the outer cap so that the caught ribs and the caught grooves are caught by each other at one or more locations, and the inner cap and the outer cap coupled to each other with the caught grooves and the caught ribs caught by each other are detached separately from each other by pulling the outer cap vertically against the inner cap, and the outer cap and the inner cap are opened and closed together by rotating the outer cap in the caught state.

7. The jar-type cosmetic container of claim 1, wherein the simultaneous rotation opening/closing means comprises one or more caught ribs and caught grooves, and the caught ribs are formed by protruding on an inner circumferential surface of an upper end of a side wall of the inner cap at proper intervals, and the caught grooves are formed longitudinally around a corresponding outer circumferential surface of a support rib extending downward from an inner circumferential surface of the outer cap, at certain intervals, and having a wave-like form or a similar form thereto so that the caught ribs and the caught grooves are caught by each other at one or more locations, and
the inner cap and the outer cap coupled to each other with the caught ribs and the caught grooves caught by each other are detached separately from each other by pulling the outer cap vertically against the inner cap, and the outer cap and the inner cap are opened and closed together by rotating the outer cap in the caught state.

8. The jar-type cosmetic container of claim 1, wherein the simultaneous rotation opening/closing means comprises a polygonal surface formed vertically around an outer circumferential surface of a side wall of the inner cap, and a polygonal surface formed around a corresponding inner circumferential surface of the outer cap so that the polygonal surfaces are contact-caught to each other, and
the inner cap and the outer cap coupled to each other with the polygonal surfaces in contact with each other are detached separately from each other by pulling the outer cap vertically against the inner cap, and the outer cap and the inner cap are opened and closed together by rotating the outer cap with the polygonal surfaces in contact with each other.

9. The jar-type cosmetic container of claim 1, wherein an inner container for accommodating the cosmetic contents is further coupled to the accommodation space of the container body to be detachable with respect to the inlet port, and an open end of the inner container is covered with the auxiliary cover.

10. The jar-type cosmetic container of claim 2, wherein an inner container for accommodating the cosmetic contents is further coupled to the accommodation space of the container body to be detachable with respect to the inlet port, and an open end of the inner container is covered with the auxiliary cover.

11. The jar-type cosmetic container of claim 3, wherein an inner container for accommodating the cosmetic contents is further coupled to the accommodation space of the container body to be detachable with respect to the inlet port, and an open end of the inner container is covered with the auxiliary cover.

12. The jar-type cosmetic container of claim 4, wherein an inner container for accommodating the cosmetic contents is further coupled to the accommodation space of the container body to be detachable with respect to the inlet port, and an open end of the inner container is covered with the auxiliary cover.

13. The jar-type cosmetic container of claim 5, wherein an inner container for accommodating the cosmetic contents is further coupled to the accommodation space of the container body to be detachable with respect to the inlet port, and an open end of the inner container is covered with the auxiliary cover.

14. The jar-type cosmetic container of claim 6, wherein an inner container for accommodating the cosmetic contents is further coupled to the accommodation space of the container body to be detachable with respect to the inlet port, and an open end of the inner container is covered with the auxiliary cover.

15. The jar-type cosmetic container of claim 7, wherein an inner container for accommodating the cosmetic contents is further coupled to the accommodation space of the container body to be detachable with respect to the inlet port, and an open end of the inner container is covered with the auxiliary cover.

16. The jar-type cosmetic container of claim 8, wherein an inner container for accommodating the cosmetic contents is further coupled to the accommodation space of the container body to be detachable with respect to the inlet port, and an open end of the inner container is covered with the auxiliary cover.
